(19) United States
(12) Patent Application Publication
(10) Pub. No.: US 2005/0274756 A1
(43) Pub. Date: Dec. 15, 2005

(54) Device for fastening an accessory to a support

(76) Inventor: Jean-Marc Seys, Fontaines Saint Martin (FR)

Correspondence Address: YOUNG & THOMPSON, 745 SOUTH 23RD STREET, 2ND FLOOR, ARLINGTON, VA, 22202, US

(21) Appl. No.: 10/865,287

(22) Filed: Jun. 10, 2004

(51) Int. Cl. B60R 9/00

(52) U.S. Cl. 224/319

(57) ABSTRACT

The present invention relates to a fastening device comprising connecting means which pass through a mounting body intended to be positioned on a support and are able to be moved by translation in a direction which is substantially orthogonal to the support, and a clamping element associated with the mounting body and acting on the connecting means by way of actuating means so as to move said connecting means in the substantially orthogonal direction. The device includes additional actuating means for pivoting the connecting means and bringing them together or moving them apart laterally, corresponding to a respective tightening or loosening operation, this taking place simultaneously with the translation movement of said connecting means.

### BACKGROUND OF THE INVENTION

The present invention relates to the technical field of accessories for vehicles, motorbikes or mopeds, and in particular of boxes intended to be mounted removably on the roof of a vehicle. Such boxes may be opened or closed by a cover.

Such boxes are generally formed by a lower shell half fastened to the roof of a vehicle and by an upper shell half forming a cover and attached to said lower shell half. Retaining means are provided between the shell halves so as to prevent them from becoming separated, especially under the effect of high forces connected, for example, to sudden braking of the vehicle or to air resistance while the vehicle is moving.

The lower shell half is fastened to the roof of a vehicle or of a car using fastening means which must for their part also resist the stresses stated above.

### DESCRIPTION OF THE PRIOR ART

Fastening devices are known which comprise connecting means which pass through a mounting body intended to be positioned on a support and are able to be moved by translation in a direction which is substantially orthogonal to the support, and a clamping element associated with the mounting body and acting on the connecting means by way of actuating means so as to move said connecting means in the substantially orthogonal direction.

Document DE-3817470 describes means for fastening a box to crossbars, themselves mounted on the roof of a vehicle.

These fastening means comprise two bolts passing through the bottom of the box with their threaded part, a connecting plate connecting the ends of the bolts in the vicinity of their heads, at least one supporting plate engaging with the threaded parts, and nuts screwed onto said threaded parts to secure the bottom of the box with the crossbars.

When the nuts are tightened, the crossbars are gripped vertically between the bottom of the box and the connecting plate, this plate forming a U-shaped part with the bolts.

The fastening means described do not seem to be adaptable to variable spacings between the crossbars when changing from one vehicle to another, unless specific or additional holes are made in the bottom of the box.

Furthermore, the fastening means do not allow the horizontal mechanical play between the crossbars and the bolts to be absorbed.

Each fastening means (there are generally four) thus comprises a set of parts which need to be disassembled and reassembled to mount the box on the roof of the vehicle. The same operations have to be repeated to remove the box from the roof, which is very time-consuming on each occasion.

Document EP-0 754 595 describes another device for fastening a box to the roof of a vehicle equipped with crossbars on its roof.

The fastening device comprises a U-shaped part whose vertical movement causes the crossbars to be gripped vertically. The positioning of the U-shaped part is provided by external toothing on its upright branches, clamping jaws actuated by a lever meshing with said branches.

The fastening device does not make it possible to take up the horizontal mechanical play between a crossbar and a U-shaped part. Furthermore, it may occur that a fastening device is locked, that is to say the U-shaped part is immobilized, even before the vertical play has been eliminated. In that case, there is no secure and reliable fastening to the crossbars. Furthermore, the fastening means are produced with complicated parts requiring specific machining operations, thus substantially increasing the manufacturing costs. The U-shaped parts must also be completely disengaged from the other elements of the fastening device before re-engaging them in said elements so that they can be correctly positioned with respect to the corresponding crossbar. All these manipulations are long and tedious.

### SUMMARY OF THE INVENTION

It is an aim of the present invention to overcome the disadvantages of the prior art and produce simple fastening devices which can be put to use extremely rapidly.

It is another aim of the present invention to produce fastening devices whose cost price is low while ensuring that the mechanical fastening of the box is designed to withstand the forces to which said box is subjected.

According to the invention, it comprises additional actuating means for pivoting the connecting means so as to bring them together or move them apart laterally, corresponding to a respective tightening or loosening operation, this taking place simultaneously with the translational movement of said connecting means.

According to one embodiment of the device according to the invention, the connecting means comprise two hooks which face one another and are formed at one of the ends of the respective rods, the other end being connected to the actuating means.

According to one embodiment of the device according to the invention, the actuating means comprise:
a drive part provided with an external thread and on which the other end of the connecting rods is mounted, said drive part being able to move translationally with respect to the mounting body,
a retaining rod which retains the clamping element on the mounting body, passes through the drive part and prevents the latter from rotating, said clamping element being mounted to rotate on said retaining rod,
and an internal thread made in the clamping element and engaging with the external thread of the drive part so as to cause the latter to slide along the retaining rod when the clamping element is rotated.

According to one embodiment of the device according to the invention, the additional actuating means comprise:
kinked passages formed in the mounting body and traversed by the connecting rods,
and kinked intermediate portions of the connecting rods, interacting with the kinked passages so as to cause said connecting rods to be brought together or moved apart, depending on the position of the drive part.

According to one embodiment of the device according to the invention, the clamping element is an internally threaded cap.

According to one embodiment of the device according to the invention, the mounting body is intended to rest on part of an accessory and the connecting rods are intended to pass through a slot-type opening made in said part of the accessory.

According to one embodiment of the device according to the invention, the accessory is the bottom of a lower shell half of a box for a vehicle.

According to one embodiment of the device according to the invention, the hooks are intended to engage with crossbars fixed to a vehicle roof.

According to one embodiment of the device according to the invention, the box intended to be fastened to the roof of a vehicle provided with crossbars comprises by way of accessory a lower shell half whose bottom is equipped with at least two fastening devices.

According to one embodiment of the device according to the invention, the box intended to be fastened to the chassis of a two-wheeled vehicle of the motorbike or moped type comprises by way of accessory a lower shell half whose bottom is equipped with at least two fastening devices.

According to one embodiment of the device according to the invention, each fastening device is able, in the “open” position, to slide along the opening made in the accessory and can be immobilized, in the “closed” position, on said accessory by actuating the clamping element.

The advantage of the fastening device according to the invention lies in the possibility of using it in various applications. Specifically, it can be used to fasten a box, or any kind of compartment, on any support and, in particular, to a luggage rack of a bicycle or a motorbike.

The fastening device according to the invention may also be used to fasten a bicycle carrier to the roof of a vehicle or to fasten any other accessory to a support.

### BRIEF DESCRIPTION OF THE DRAWINGS

Other features and advantages will also become apparent from the detailed description given below with reference to the drawings which have been appended as nonlimiting, illustrative examples, in which:

FIG. 1 is an exploded perspective view of the fastening device according to the invention,

FIG. 2 is a lateral sectional view of the device according to the invention in the open position,

FIG. 3 represents the fastening device of FIG. 2 in the clamping position,

FIG. 4 is a section on IV-IV of the fastening device of FIG. 1 in plan view,

FIG. 5 is a perspective of the bottom of the box fastened to crossbars using fastening means according to the invention.

### DESCRIPTION OF THE PREFERRED EMBODIMENTS

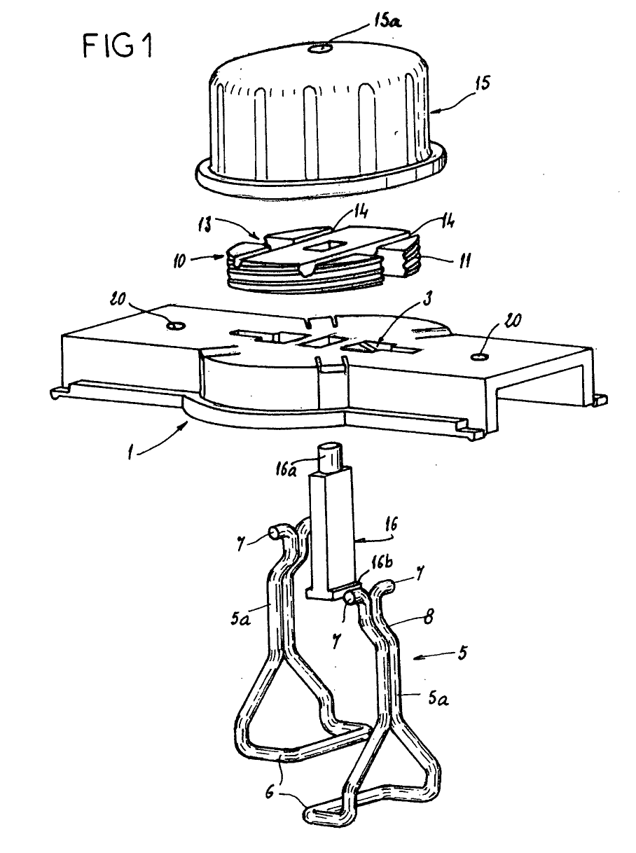

FIG. 1 shows a fastening device according to the invention in a perspective exploded view.

The fastening device comprises a mounting body 1, in the form of a parallelepipedal part, for example, in which there are made a central opening 2 and kinked passages 3 formed on either side of said central opening 2.

The mounting body 1 depicted in FIG. 1 has an approximately inverted U shape intended to bear on a support.

The fastening device also comprises two connecting rods 5, one of the ends of which is provided with a hook 6 and the other end 7 of which has a hooking means. The connecting rod 5 also has an intermediate part 5a and a kinked part 8 intended to interact with the respective kinked passage 3, the other end 7 forming a hooking means used for driving said connecting rod 5 through the corresponding kinked passage 3.

As a variant, any other combination of forms between the connecting rods 5 and the kinked passages 3 may also be conceived of within the framework of the present invention.

By way of example, the connecting rods 5 are produced with a solid metal rod of cylindrical cross section, the curving of which respectively forms the hooks 6, the straight intermediate part 5a, the kinked part 8, and the hooking means in the form of a curved end 7.

The fastening device also comprises a substantially cylindrical drive part 10 provided with an external thread 11. A central passage 12 is made in the drive part 10 together with lateral cutouts 13 which run into bearing grooves 14 located on either side of the central passage 12. The cutouts 13 are used to mount the connecting rods 5 on the drive parts 10 and, more precisely, to position the other curved ends 7 of each connecting rod 5 in the respective bearing groove 14.

The dimensions and the shapes of the kinked passages 3 are designed to allow translational movement of the connecting rods 5 on the one hand and, on the other hand, to allow said connecting rods 5 to pivot about pivoting axes defined by the bearing grooves 14. The action of the intermediate part 5a and the kinked part 8 passing successively through the kinked passage 3 forms the basis for moving apart and bringing together the hooks 6.

The fastening device also comprises a clamping element 15 produced in the form of an internally threaded cap which is mounted to rotate freely on the mounting body 1. The clamping element 15 has an internal thread 15b engaging with the external thread 11 of the drive part 10. The clamping element 15 is maintained against the mounting body 1 using a mounting rod 16. The latter makes it possible to retain the clamping element 15 while enabling it to turn about its axis of symmetry. To this end, the mounting rod 16 has a cylindrical end 16a engaging in a circular opening 15a made in the upper part of the clamping element 15.

Various means known per se, for example material deformation, are provided on the cylindrical end 16a of the mounting rod 16 in order to prevent translational movement by said clamping element 15.

The mounting rod 16 is also provided with a ledge 16b at its opposite end to the cylindrical part 16a so as to prevent it passing through the central opening 2, said ledge 16b butting against the mounting body 1.

Apart from these two ends, the mounting rod 16 has a section, for example a rectangular section, so as to prevent any rotation about its longitudinal axis, likewise corresponding to the axis for mounting it on the mounting body 1 and in the clamping element 15.

The central passage 12 advantageously has a rectangular shape complementing that of the mounting rod 16 so as to be likewise prevented from rotating with the latter. By rotating the clamping element 15, and by way of the engagement of the external thread 11 in the internal thread 15b of the clamping element 15, it is thus possible to achieve translational movement of the drive part 10, the latter sliding along the mounting rod 16 and driving the connecting rods 5 with it.

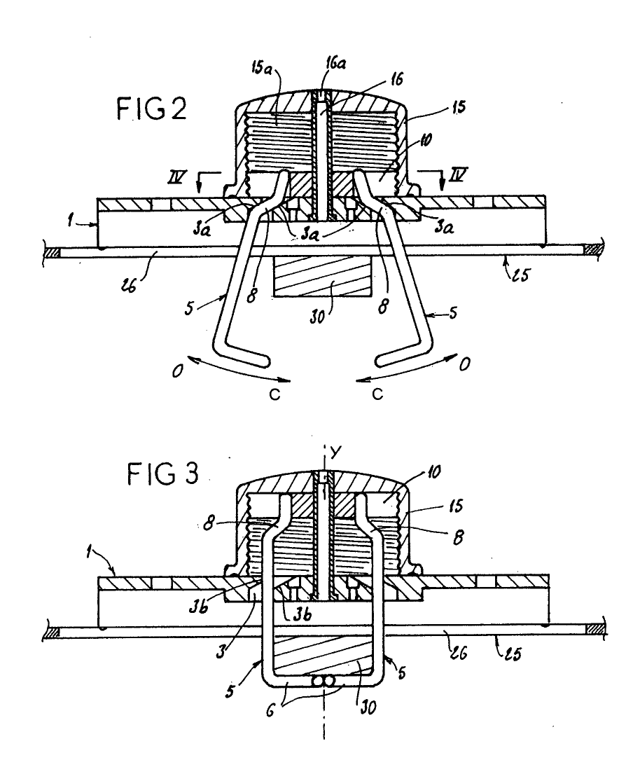

FIGS. 2 and 3 show a section through the fastening device according to the invention in position, that is to say in a first, “open” position (FIG. 2) and in a second, “closed” position (FIG. 3).

FIG. 2 shows a section through the fastening device according to the invention. In the latter, the drive part 10 bears against the upper surface of the mounting body 1 and the connecting rods 5 are moved apart in the direction of the arrow O. This moving-apart corresponds to interaction between the kinked parts 8 and the corresponding kinked passages 3 formed in the mounting body 1. To this end, the kinked passages 3 have oblique segments 3a against which the kinked parts 8 bear, thus forcing the latter to move apart and consequently release a crossbar 30 fixed, for example, to the roof of a vehicle. Each connecting rod 5 extends through a slot 26 made in an accessory 25 formed, for example, by the bottom of the lower shell of a box intended to be mounted on the roof of a vehicle.

When a user activates the clamping element 15, that is to say when he turns the latter about its axis Y-Y′, the drive part 10, prevented from rotating, is translated upward to bear against the upper inside wall of the clamping element 15. The hooks 6 are thus driven upward, that is to say in the direction of the mounting body 1. In such a position, it is the straight intermediate branches 5a which pass through the kinked passages 3. It is therefore these same straight intermediate branches 5a which bear against substantially vertical segments 3b of the respective kinked passages 3. Such an interaction forces the connecting rods 5, and consequently the hooks 6, to close up, that is to say to pivot in the direction of the arrow C. The hooks 6, and consequently also the connecting rods 5, thus grip the crossbar 30 laterally and vertically. Any horizontal and vertical play is thus taken up by the fastening device according to the invention.

The holes 20 are advantageously provided to position the fastening devices in a stable manner with respect to the positions of the crossbars 30. Immobilization means known per se are thus fitted through the holes 20.

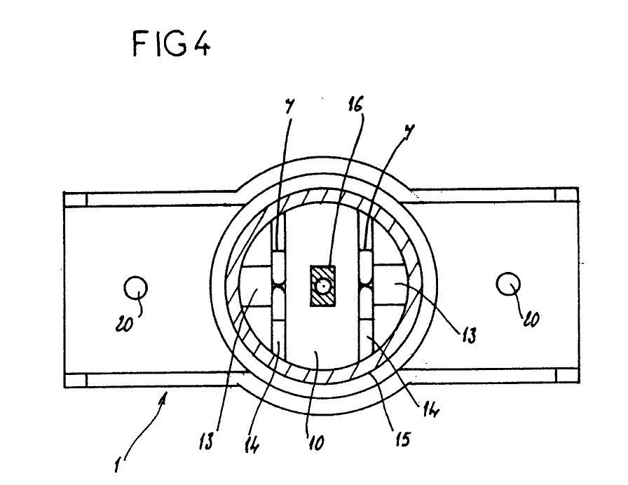

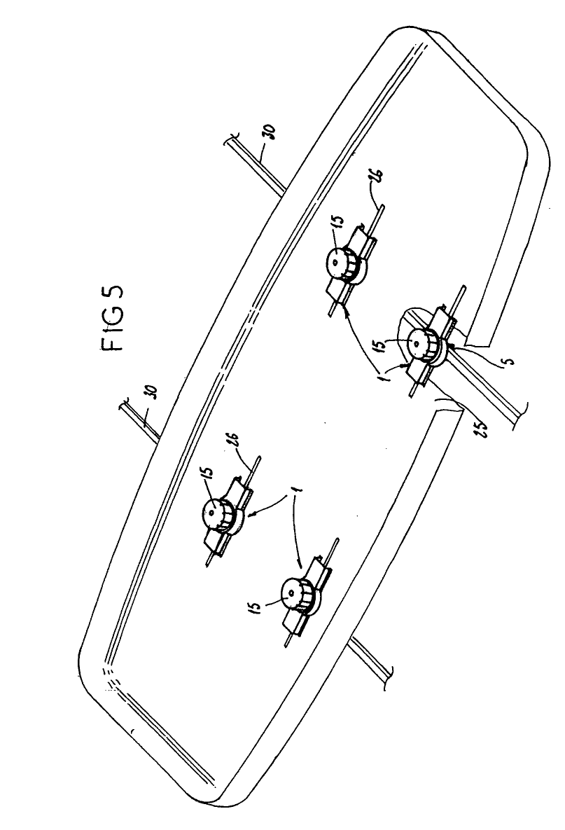

FIG. 4 is a section on IV-IV of FIG. 2 and particularly shows the positioning of the curved ends 7 in the corresponding bearing grooves 14 formed in the drive part 10.

FIG. 5 shows the fastening devices according to the invention mounted on the bottom 25 of a shell half of a box for a vehicle. The bottom 25 is provided with slots 26 on which said fastening devices are positioned and, where appropriate, immobilized.

The lower shell half of the box can thus be adapted in an extremely simple manner to variable spacings between the crossbars 30 fixed to the roof of a vehicle. All that is required to do this is to slide the fastening devices along the slots 26, with no special tools being needed for this purpose.

1. A fastening device, comprising:
connecting means which pass through a mounting body positionable on a support, where the connecting means are able to be moved by translation in a direction which is substantially orthogonal to the support;
a clamping element associated with the mounting body and acting on the connecting means by way of actuating means so as to move said connecting means in the substantially orthogonal direction;
additional actuating means for pivoting the connecting means and bringing them together or moving them apart laterally, corresponding to a respective tightening or loosening operation, this taking place simultaneously with the translational movement of said connecting means.

2. The fastening device as claimed in claim 1, wherein the connecting means comprise two hooks which face one another and are formed at one end of the connecting means, an other end thereof being connected to the actuating means.

3. The fastening device as claimed in claim 2, wherein the actuating means comprise:
a drive part provided with an external thread and on which the other end of the connecting means is mounted, said drive part being able to move translationally with respect to the mounting body,
a retaining rod which retains the clamping element on the mounting body, passes through the drive part and prevents the latter from rotating, said clamping element being mounted to rotate on said retaining rod,
an internal thread made in the clamping element and engaging with the external thread of the drive part so as to cause the latter to slide along the retaining rod when the clamping element is rotated.

4. The fastening device as claimed in claim 3, wherein the additional actuating means comprise:
kinked passages formed in the mounting body and traversed by the connecting means,
and kinked parts on the connecting means, which interact with the kinked passages so as to cause said connecting means to be brought together or moved apart, depending on a position of the drive part.

5. The fastening device as claimed in claim 3, wherein the clamping element is an internally threaded cap.

6. The fastening device as claimed in claim 1, wherein the mounting body is disposed on part of an accessory, the connecting means passing through a slot-type opening made in said part of the accessory.

7. The fastening device as claimed in claim 6, wherein the accessory is a bottom of a lower shell half of a box for a vehicle.

8. The fastening device as claimed in claim 2, wherein the hooks engage with crossbars fixed to a vehicle roof.

9. A box intended to be fastened to a roof of a vehicle provided with crossbars, comprising a lower shell half having a bottom equipped with at least two fastening devices as claimed in claim 1.

10. A box intended to be fastened to a chassis of a two-wheeled vehicle of a motorbike or moped type, comprising a lower shell half having a bottom equipped with at least two fastening devices as claimed in claim 1.

11. The box as claimed in claim 9, wherein each fastening device is able, in an “open” position, to slide along an opening made in the bottom and can be immobilized, in a “closed” position, on said bottom by actuating the clamping element.

12. The box as claimed in claim 10, wherein each fastening device is able, in an “open” position, to slide along an opening made in the bottom and can be immobilized, in a “closed” position, on said bottom by actuating the clamping element.

13. The box as claimed in claim 6, wherein each fastening device is able, in an “open” position, to slide along an opening made in a bottom and can be immobilized, in a “closed” position, on said bottom by actuating the clamping element.
